(19) United States
(12) Patent Application Publication
(10) Pub. No.: US 2016/0034365 A1
(43) Pub. Date: Feb. 4, 2016

(54) INFORMATION PROCESSING SYSTEM, INFORMATION PROCESSING APPARATUS, REDUNDANCY PROVIDING METHOD, AND PROGRAM

(71) Applicant: NEC Corporation, Tokyo (JP)

(72) Inventor: Daisuke AGEISHI, Tokyo (JP)

(21) Appl. No.: 14/794,840

(22) Filed: Jul. 9, 2015

(30) Foreign Application Priority Data
Aug. 1, 2014 (JP) 2014-157267

(51) Int. Cl. G06F 11/20

(52) U.S. Cl. CPC G06F 11/2007; G06F 2201/805

(57) ABSTRACT

In an information processing system including I/O cards provided with redundancy, the disclosed system and method realize a fail-over that enables improvement of the availability of the information processing apparatus. An information processing system constituting the information processing apparatus includes first and second I/O cards; a BIOS that performs a detection of a correctable failure of the first I/O card; a predictive monitoring unit that performs a predictive detection of a sign of an occurrence of a hardware failure of the first I/O card when a result of the detection of the correctable failure indicates an occurrence of the correctable failure; and an OS that disconnects the first I/O card and performs switching from the first I/O card to the second I/O card when a result of the predictive detection indicates an existence of the sign of the occurrence of the hardware failure of the first I/O card.

This application is based upon and claims the benefit of priority from Japanese Patent Application No. 2014-157267, filed on Aug. 1, 2014, the disclosure of which is incorporated herein in its entirety by reference.

### TECHNICAL FIELD

The present invention relates to a technology for improving the availability of an information processing apparatus by providing input/output interfaces included therein with redundancy.

### BACKGROUND ART

For information processing apparatuses, such as a server, network interface card (NIC) teaming (or bonding) has been well known as a technology for improving the availability of the information processing apparatus by providing input/output (I/O) interfaces included therein with redundancy. This NIC teaming is a technology for improving the availability of the information processing apparatus by, when a communication failure, such as a link down failure, is detected in an NIC in an active mode, performing a fail-over from the NIC in an active mode to an NIC in a standby mode.

The NIC teaming, however, intends to monitor only communication failures detectable by software (SW), but does not intend to monitor hardware (HW) failures of the NICs. For this reason, when a HW failure occurs in an NIC and this HW failure leads to an uncorrectable failure, the information processing apparatus (server) itself comes into a down state. Thus, for the NIC teaming, the availability of the information processing apparatus (server) has been insufficient in a respect that, even though I/O interfaces included therein are provided with redundancy, any occurrence of a HW failure in an I/O interface brings the information processing apparatus (server) into a down state.

In Japanese Laid-open Patent Publication No. 2010-244396, there is disclosed a technology for, when a sign of the occurrence of a failure is detected in an input/output process module for controlling input/output of data between a peripheral device and an information processing apparatus, performing switching from the input/output process module to a spare input/output process module before the occurrence of a failure of the input/output process module. In addition, this input/output process module is a module for performing correspondence of information by controlling a relevant I/O card. In Japanese Laid-open Patent Publication No. 2010-244396, however, any countermeasure in relation to hardware failures of I/O cards is not disclosed. Further, there occurs a case where an I/O card that is not provided with redundancy is operating, and such a case results in an existence of a singular I/O card having no substitute in a system. For this reason, if an I/O card is disconnected when a sign of the occurrence of a HW failure thereof has been detected, there is likely to occur a situation in which a singular I/O card comes into an unusable state. Accordingly, it is required to take a countermeasure that is specific to I/O cards and that is either a setting of a threshold value, which is for use in determination of a sign of the occurrence of a HW failure in an I/O card, to a relatively high value, or a prohibition of disconnection of a singular I/O card.

### SUMMARY

The present invention has been made in view of the above-described problems and is intended to, in an information processing apparatus including I/O cards provided with redundancy, realize a fail-over that enables improvement of the availability of the information processing apparatus.

An information processing system according to an exemplary aspect of the present invention includes a first I/O card and a second I/O card; a basic input/output system (BIOS) that detects a correctable failure of the first I/O card; a predictive monitoring means that performs a predictive detection of a sign of an occurrence of a hardware failure of the first I/O card when a result of the detection of the correctable failure indicates an occurrence of the correctable failure; and an operating system (OS) that disconnects the first I/O card and performs switching from the first I/O card to the second I/O card when a result of the predictive detection indicates an existence of the sign of the occurrence of the hardware failure of the first I/O card.

An information processing apparatus according to an exemplary aspect of the present invention includes a first I/O card and a second I/O card; a BIOS that detects a correctable failure of the first I/O card; a predictive monitoring means that performs a predictive detection of a sign of an occurrence of a hardware failure of the first I/O card when a result of the detection of the correctable failure indicates an occurrence of the correctable failure; and an OS that disconnects the first I/O card and performs switching from the first I/O card to the second I/O card when a result of the predictive detection indicates an existence of the sign of the occurrence of the hardware failure of the first I/O card.

A redundancy providing method according to an exemplary aspect of the present invention includes detecting a correctable failure of a first I/O card; performing a predictive detection of a sign of an occurrence of a hardware failure of the first I/O card when a result of the detection of the correctable failure indicates an occurrence of the correctable failure; and disconnecting the first I/O card and performing switching from the first I/O card to a second I/O card when a result of the predictive detection indicates an existence of the sign of the occurrence of the hardware failure of the first I/O card.

A redundancy providing program according to an exemplary aspect of the present invention causes processing to be executed, the processing including a process of detecting a correctable failure of a first I/O card; a process of performing a predictive detection of a sign of an occurrence of a hardware failure of the first I/O card when a result of the detection of the correctable failure indicates an occurrence of the correctable failure; and a process of disconnecting the first I/O card and performing switching from the first I/O card to a second I/O card when a result of the predictive detection indicates an existence of the sign of the occurrence of the hardware failure of the first I/O card.

### BRIEF DESCRIPTION OF THE DRAWINGS

Exemplary features and advantages of the present invention will become apparent from the following detailed description when taken with the accompanying drawings in which:

FIG. 1 is a block diagram showing the configuration of an information processing system according to an exemplary embodiment of the present invention;

FIG. 2 is a block diagram showing the configuration of an information processing system according to an exemplary embodiment of the present invention;

FIG. 3 is a block diagram showing the hardware configuration of an information processing system according to an exemplary embodiment of the present invention; and

FIG. 4 is a flowchart showing the operation of an information processing system according to an exemplary embodiment of the present invention.

### EXEMPLARY EMBODIMENT

Hereinafter, an exemplary embodiment of the present invention will be described in detail with reference to the drawings. It is to be noted that an exemplary embodiment described below is subjected to some limitations that are technically desirable in the practice of the present invention, but these limitations are not intend to limit the scope of the present invention to the exemplary embodiment described below.

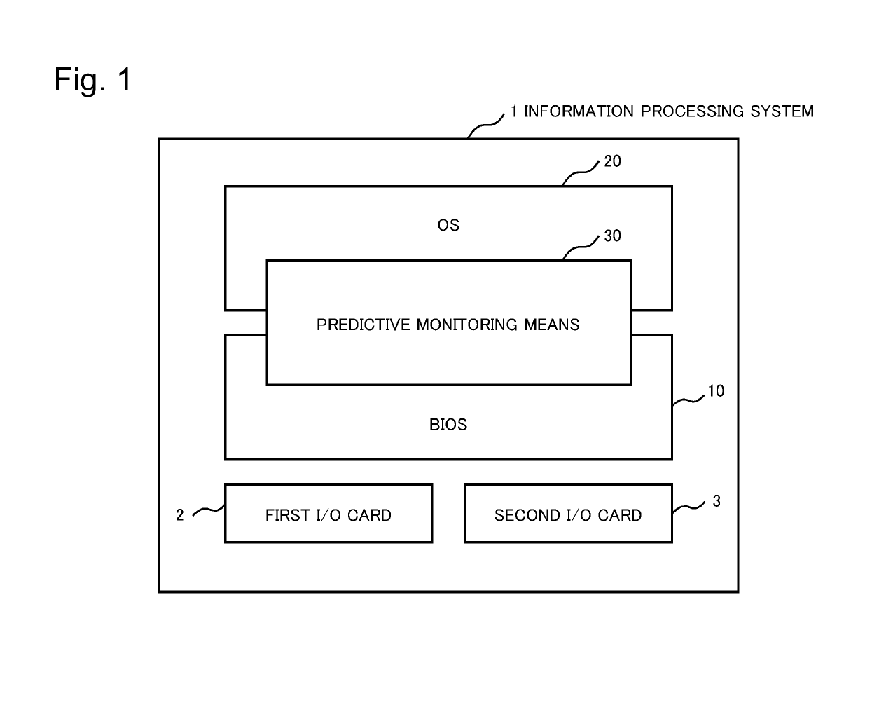

FIG. 1 is block diagram showing the configuration of an information processing system according to this exemplary embodiment of the present invention. An information processing system 1 according to this exemplary embodiment includes a first I/O card 2; a second I/O card 3; and a BIOS 10 for detecting a correctable failure of the first I/O card 2. Moreover, the information processing system 1 includes a predictive monitoring means 30 that performs a predictive detection of a hardware failure of the first I/O card 2 on the basis of a result of the detection of the correctable failure; and an OS 20 that disconnects the first I/O card 2 and performs switching from the first I/O card 2 to the second I/O card 3 on the basis of a result of the predictive detection.

According to this exemplary embodiment, it is possible to, in an information processing apparatus including I/O cards provided with redundancy, realize a fail-over that enables improvement of the availability of the information processing apparatus.

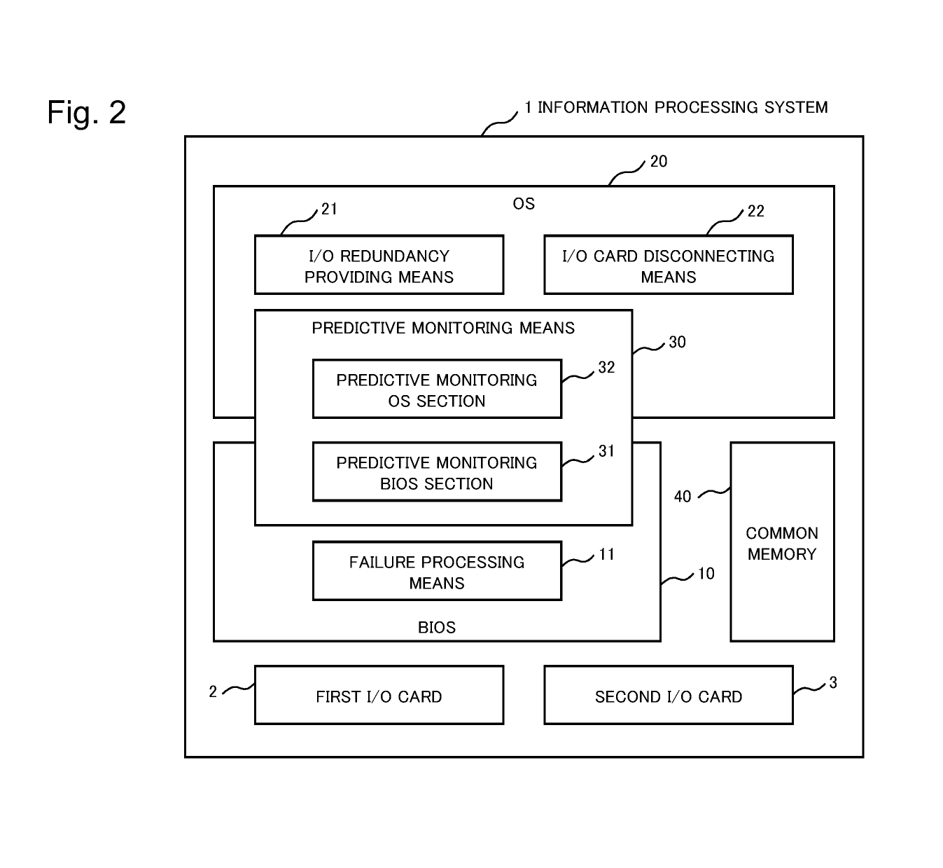

Hereinafter, more specifically, the configuration of the information processing system 1 according to this exemplary will be described. FIG. 2 is block diagram showing the detailed configuration of the information processing system 1 according to this exemplary embodiment. The information processing system 1 according to this exemplary embodiment includes the BIOS 10; the OS 20; the first I/O card 2; and the second I/O card 3. The first I/O card 2 and the second I/O card 3 can be configured to operate in an active mode and in a standby mode, respectively. In the information processing system 1 including such redundant I/O cards, there is provided the predictive monitoring means 30 that is used in common by both of the BIOS 10 and the OS 20.

The BIOS 10 includes a failure processing means 11 for detecting failures of hardware components, such as I/O cards. The OS 20 includes an I/O redundancy providing means 21 having the function of the NIC teaming; and an I/O card disconnecting means 22 having a peripheral component interconnect (PCI) based hot removal function.

In the BIOS 10, the predictive monitoring means 30 includes a predictive monitoring BIOS section 31 that is interfaced with the failure processing means 11. In the OS 20, the predictive monitoring means 30 includes a predictive monitoring OS section 32 that is interfaced with the I/O redundancy providing means 21 and the I/O card disconnecting means 22. Moreover, the information processing system 1 includes a common memory 40 that allows both of the predictive monitoring BIOS section 31 and the predictive monitoring OS section 32 to have information in common.

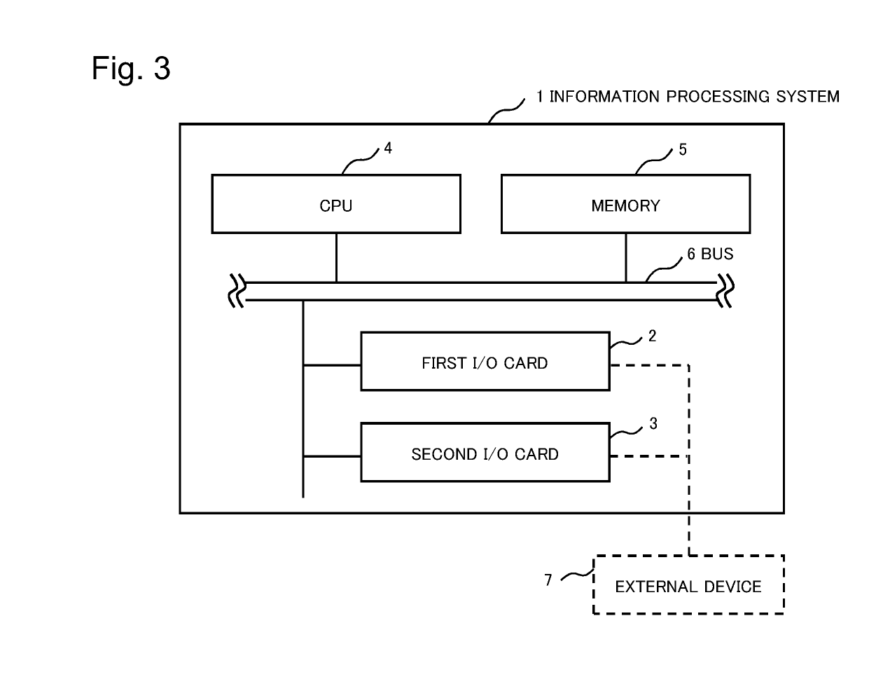

FIG. 3 is block diagram showing a hardware configuration that realizes the functional configuration of the information processing system 1, shown in FIG. 2. The information processing system 1 is information equipment, such as a server, which includes a central processing unit (CPU) 4; a memory 5; the first I/O card 2; and the second I/O card 3, these components being electrically connected to a bus 6. An external device 7 is communicably connected to the bus 6 via any one of the first I/O card 2 and the second I/O card 3. The configuration of the information processing system 1, shown in FIG. 2, can be realized by allowing the CPU 4 to execute programs while using calculation resources provided in the CPU 4 itself and storage resources provided in the memory 5, and further by allocating storage areas of the memory 5 to the individual functional components of the information processing system 1, shown in FIG. 2.

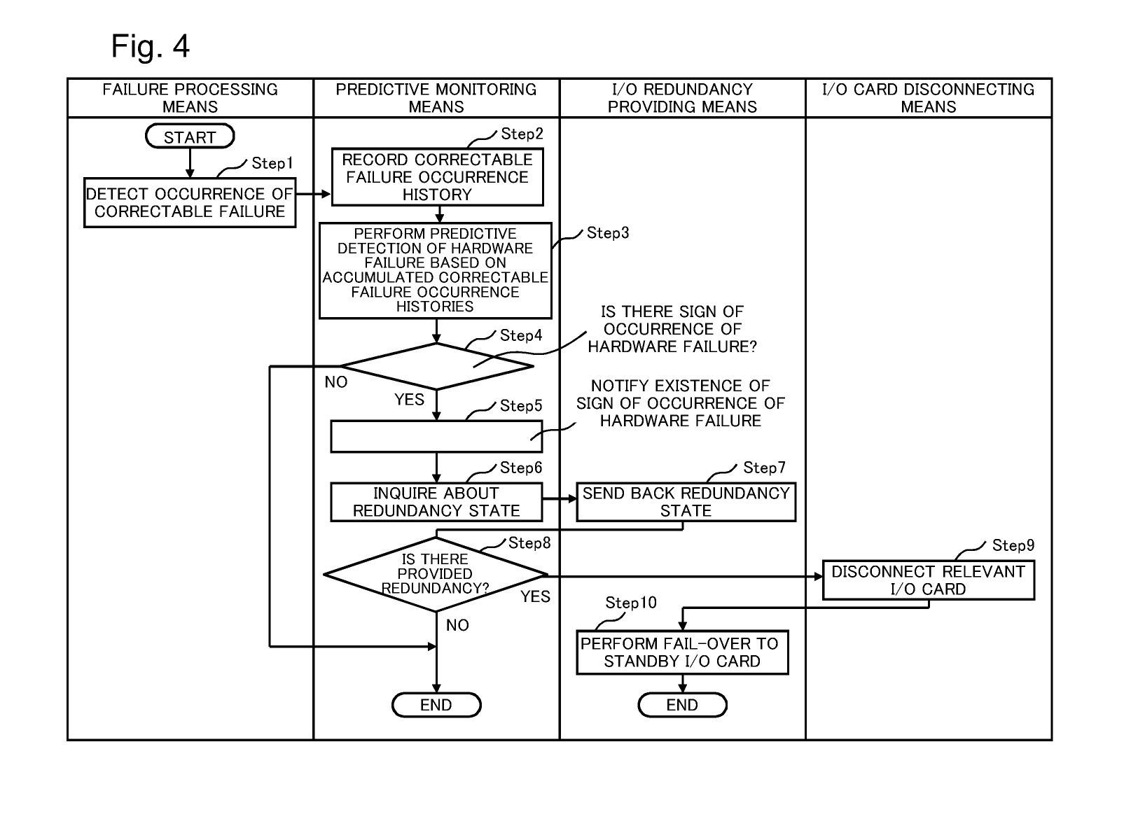

Next, the operation of the information processing system 1 according to this exemplary embodiment will be described for each of steps. FIG. 4 is a flowchart showing the operation of the information processing system 1 shown in FIG. 2. Hereinafter, operation for each step will be described. In addition, the details of each operation will be described below.

(Step 1) Upon detection of a correctable failure of the first I/O card 2, the failure processing means 11 of the BIOS 10 notifies the predictive monitoring BIOS section 31 of the predictive monitoring means 30 of this event in which a correctable failure of the first I/O card 2 has been detected.

(Step 2) Upon reception of the notification of the correctable failure of the first I/O card 2 from the failure processing means 11, the predictive monitoring BIOS section 31 stores a correctable failure occurrence history into the common memory 40.

(Step 3) The predictive monitoring BIOS section 31 determines whether or not there exists a sign of the occurrence of a failure in the first I/O card 2, on the basis of correctable failure occurrence histories that are accumulated in the common memory 40.

(Step 4) When having determined that there exists a sign of the occurrence of a failure in the first I/O card 2 (YES), the predictive monitoring BIOS section 31 allows this process flow to proceed to step 5. When having determined that there does not exist any sign of the occurrence of a failure in the first I/O card 2 (NO), the predictive monitoring BIOS section 31 terminates this process flow.

(Step 5) The predictive monitoring BIOS section 31 notifies the predictive monitoring OS section 32 of the detection result indicating the existence of a sign of the occurrence of a failure in the first I/O card 2.

(Step 6) Upon reception of the notification for notifying the existence of a sign of the occurrence of a failure in the first I/O card 2, the predictive monitoring OS section 32 inquires of the I/O redundancy providing means 21 about a redundancy state of the first I/O card 2.

(Step 7) Upon reception of the inquiry, the I/O redundancy providing means 21 sends back a response for notifying the redundancy state thereof to the predictive monitoring OS section 32. In this case, the sent-back response notifies that redundancy is provided to the first I/O card 2 and the second I/O card 3 exists as a standby I/O card for the first I/O card 2.

(Step 8) In the case where redundancy is provided (YES), the predictive monitoring OS section 32 instructs the I/O card disconnecting means 22 to disconnect the first I/O card 2. In the case where redundancy is not provided (NO), the predictive monitoring OS section 32 terminates this process flow.

(Step 9) Upon reception of the instruction for instructing the disconnection, the I/O card disconnecting means 22 disconnects the first I/O card 2, and instructs the I/O redundancy providing means 21 to perform a fail-over from the first I/O card 2 to the second I/O card 3.

(Step 10) Upon reception of the instruction for instructing execution of the fail-over, the I/O redundancy providing means 21 performs a fail-over from the first I/O card 2 to the second I/O card 3.

Next, the details of the above-described operation for each step will be described below.

In the case where a failure of the first I/O card 2 is detected by using a failure detection function provided in the first I/O card 2 itself, relevant operation can be performed by using a method prescribed in the PCI standard specification. In this case, the failure is reported in the form of an ERR_*Message. The destination of an interrupt to be issued when this ERR_*Message has occurred can be set to any one of the BIOS 10 and the OS 20. That is, it is possible to select any one of two kinds of interrupt issuing methods, one being a method of issuing a system management interrupt (SMI) to the BIOS 10, the other one being a method of issuing a message signaled interrupt (MSI) to the OS 20. In this exemplary embodiment, the method of issuing the SMI is employed.

In step 1, when a failure of the first I/O card 2 has been detected by using the failure detection function provided in the first I/O card 2, the SMI is issued to the BIOS 10 and the failure processing means 11 starts operation. The failure processing means 11 determines whether the failure having been detected by using the failure detection function provided in the first I/O card 2 is a correctable failure or an uncorrectable failure.

The determination as to whether the detected failure is a correctable failure or an uncorrectable failure can be made by using a method prescribed in the PCI standard specification. Specifically, an advanced error reporting of the PCI standard specification is used. The failure processing means 11 can determine whether the failure having been detected by using the failure detection function provided in the first I/O card 2 is a correctable failure or an uncorrectable failure, by referring to a register provided in an I/O card prescribed in the advanced error reporting of the PCI standard specification.

When having determined that a correctable failure has occurred in the first I/O card 2, the failure processing means 11 notifies the predictive monitoring BIOS section 31 of the occurrence of the correctable failure. In contrast, when having determined that an uncorrectable failure has occurred in the first I/O card 2, the failure processing means 11 issues a non-maskable interrupt (NMI); retrieves crash dump data; and causes the first I/O card 2 to restart on the basis of the crash dump data.

In step 2, the predictive monitoring BIOS section 31 records a correctable failure occurrence history into the common memory 40. Through this recording, it is recorded how many times a correctable failure has occurred during a constant period.

In step 3, in the case where, as a result of the recording in step 2, the total number of failure occurrences per constant period has exceeded a reference value, the predictive monitoring BIOS section 31 determines that there is a sign of the occurrence of a failure in the first I/O card 2. In this case, the result of the determination in step 4 is YES, and the process flow proceeds to step 5.

In step 5, it is possible to, as a method for allowing the predictive monitoring BIOS section 31 to notify the predictive monitoring OS section 31 of the detection result indicating the existence of a sign of the occurrence of a failure, select any one of two methods, one being an interrupt method, the other one being a polling method. Whichever of these two methods is selected, in order to enable the predictive monitoring BIOS section 31 and the predictive monitoring OS section 32 to have information in common, before the launch of the OS 20 after the start-up of the information processing system 1, the BIOS 10 is allowed to reserve the common memory 40 in advance such that the area of the common memory 40 becomes a fixed memory address space. The recording of a correctable failure occurrence history into the common memory 40 configured in such a way makes it possible to transfer information related to the correctable failure occurrence history between the predictive monitoring BIOS section 31 and the predictive monitoring OS section 32.

In step 5, in the case where the interrupt method is selected, during an initialization process at the start-up, the predictive monitoring OS section 32 makes a request for allocation of an interrupt using an interrupt request (IRQ) to the OS 20, and thereby secures an IRQ based dedicated interrupt. Further, the predictive monitoring OS section 32 stores an IRQ number of the secured interrupt into the common memory 40. The predictive monitoring BIOS section 31 obtains the IRQ number by referring to the common memory 40, and then issues the IRQ based dedicated interrupt to the OS 20. In this way, the predictive monitoring BIOS section 31 notifies the predictive monitoring OS section 32 of the detection result indicating the existence of a sign of the occurrence of a failure.

In step 5, in the case where the polling method is selected, the predictive monitoring OS section 32 periodically refers to the common memory 40 and thereby confirms whether or not the predictive monitoring BIOS section 31 has detected a sign of the occurrence of a failure. Upon detection of a sign of the occurrence of a failure, the predictive monitoring BIOS section 31 stores the detection result indicating the existence of the sign into the common memory 40.

In step 6, the predictive monitoring OS section 32 inquires of the I/O redundancy providing means 21 about a redundancy state of the first I/O card 2 which is in an active mode. Specifically, the predictive monitoring OS section 32 inquires of the I/O redundancy providing means 21 by using a command, an application programming interface (API), or the like, that is provided by the I/O redundancy providing means 21.

In step 7 and step 8, when having known that redundancy is provided to the first I/O card 2 in which a sign of the occurrence of a failure has been detected, the predictive monitoring OS section 32 instructs the I/O card disconnecting means 22 of the OS 20 to disconnect the first I/O card 2. The disconnection of the first I/O card 2 is performed by using the PCI based hot removal function provided by the OS 20. As a method for instructing the execution of the PCI based hot removal function, there are two kinds of methods, one being a method of directly executing a command provided by the OS 20, the other one being a method of issuing an ejection notification from an advanced configuration and power interface (ACPI). The predictive monitoring OS section 32 may use any one of these methods.

In step 9, upon reception of the instruction for instructing execution of the disconnection, the I/O card disconnecting means 22 disconnects the first I/O card 2, and instructs the I/O redundancy providing means 21 to perform a fail-over from the first I/O card 2 to the second I/O card 3.

In step 10, upon reception of the instruction for instructing execution of the fail-over, the I/O redundancy providing means 21 performs the fail-over from the first I/O card 2 to the second I/O card 3.

According to the information processing system 1 of this exemplary embodiment, a sign of the occurrence of a hardware failure in an I/O card is detected from occurrence histories of correctable failures having occurred in the I/O card and on a peripheral component interconnect express (PCIe) bus therefor. Further, only when redundancy is provided to the first I/O card, it is possible to disconnect the first I/O card 2 in an active mode and perform a fail-over from the first I/O to the second I/O card 3 in a standby mode.

An information processing apparatus according to this exemplary embodiment is an information processing apparatus, such as a server, that incorporates the information processing system 1 according to this exemplary embodiment. A redundancy providing method according to this exemplary embodiment is a redundancy providing method that performs the operation of the information processing system 1 according to this exemplary embodiment. A storage medium storing therein a redundancy providing program according to this exemplary embodiment is a storage medium storing therein a redundancy providing program that causes the operation of the information processing system 1 according to this exemplary embodiment to be executed.

According to this exemplary embodiment, it is possible to, in an information processing apparatus including I/O cards provided with redundancy, realize a fail-over that enables improvement of the availability of the information processing apparatus.

The present invention is not limited to the aforementioned embodiment, and can be embodied as various modified embodiments within the scope of the present invention, set forth in appended claims, but, naturally, such modified embodiments are encompassed by the present invention.

Further, partial portions or the entire portion of the aforementioned embodiment can be described as, but is not limited to, the following supplementary notes.

### Supplementary Notes

### (Supplementary Note 1)

An information processing system including:

a first I/O card and a second I/O card;

a BIOS that performs a detection of a correctable failure of the first I/O card;

a predictive monitoring means that performs a predictive detection of a sign of an occurrence of a hardware failure of the first I/O card when a result of the detection of the correctable failure indicates an occurrence of the correctable failure; and

an OS that disconnects the first I/O card and performs switching from the first I/O card to the second I/O card when a result of the predictive detection indicates an existence of the sign of the occurrence of the hardware failure of the first I/O card.

### (Supplementary Note 2)

The information processing system according to supplementary note 1, wherein the predictive monitoring means includes a predictive monitoring BIOS section that receives a notification for notifying the occurrence of the correctable failure from the BIOS, and a predictive monitoring OS section that notifies the OS of the predictive detection result indicating the existence of the sign of the occurrence of the hardware failure of the first I/O card.

### (Supplementary Note 3)

The information processing system according to supplementary note 2, wherein the predictive monitoring BIOS section and the predictive monitoring OS section have a common memory in common, and the common memory records therein the correctable failure detection result indicating the occurrence of the correctable failure.

### (Supplementary Note 4)

The information processing apparatus according to supplementary note 3, wherein the predictive monitoring BIOS section records the predictive detection result indicating the existence of the sign of the occurrence of the hardware failure of the first I/O card into the common memory.

### (Supplementary Note 5)

The information processing apparatus according to supplementary note 4, wherein the predictive monitoring OS section acquires the predictive detection result indicating the existence of the sign of the occurrence of the hardware failure of the first I/O card from the common memory.

### (Supplementary Note 6)

The information processing system according to any one of supplementary notes 1 to 5, wherein the predictive monitoring means performs the predictive detection on the basis of a failure occurrence history with respect to the correctable failure.

### (Supplementary Note 7)

The information processing system according to any one of supplementary notes 1 to 6, wherein the first I/O card is in an active mode and the second I/O card is in a standby mode.

### (Supplementary Note 8)

An information processing apparatus including:

a first I/O card and a second I/O card;

a BIOS that performs a detection of a correctable failure of the first I/O card;

a predictive monitoring means that performs a predictive detection of a sign of an occurrence of a hardware failure of the first I/O card when a result of the detection of the correctable failure indicates an occurrence of the correctable failure; and

an OS that disconnects the first I/O card and performs switching from the first I/O card to the second I/O card when a result of the predictive detection indicates an existence of the sign of the occurrence of the hardware failure of the first I/O card.

### (Supplementary Note 9)

The information processing apparatus according to supplementary note 8, wherein the predictive monitoring means includes a predictive monitoring BIOS section that receives a notification for notifying the occurrence of the correctable failure from the BIOS, and a predictive monitoring OS section that notifies the OS of the predictive detection result indicating the existence of the sign of the occurrence of the hardware failure of the first I/O card.

### (Supplementary Note 10)

The information processing apparatus according to supplementary note 9, wherein the predictive monitoring BIOS section and the predictive monitoring OS section have a common memory in common, and the common memory records therein the correctable failure detection result indicating the occurrence of the correctable failure.

### (Supplementary Note 11)

The information processing apparatus according to supplementary note 10, wherein the predictive monitoring BIOS section records the predictive detection result indicating the existence of the sign of the occurrence of the hardware failure of the first I/O card into the common memory.

### (Supplementary Note 12)

The information processing apparatus according to supplementary note 11, wherein the predictive monitoring OS section acquires the predictive detection result indicating the existence of the sign of the occurrence of the hardware failure of the first I/O card from the common memory.

### (Supplementary Note 13)

The information processing apparatus according to any one of supplementary notes 8 to 12, wherein the predictive monitoring means performs the predictive detection on the basis of a failure occurrence history with respect to the correctable failure.

### (Supplementary Note 14)

The information processing apparatus according to any one of supplementary notes 8 to 13, wherein the first I/O card is in an active mode and the second I/O card is in a standby mode.

### (Supplementary Note 15)

A redundancy providing method including:

performing a detection of a correctable failure of a first I/O card;

performing a predictive detection of a sign of an occurrence of a hardware failure of the first I/O card when a result of the detection of the correctable failure indicates an occurrence of the correctable failure; and

disconnecting the first I/O card and performing switching from the first I/O card to a second I/O card when a result of the predictive detection indicates an existence of the sign of the occurrence of the hardware failure of the first I/O card.

### (Supplementary Note 16)

The redundancy providing method according to supplementary note 15, wherein the operation of performing the detection of the correctable failure is performed by a BIOS.

### (Supplementary Note 17)

The redundancy providing method according to supplementary note 15 or supplementary note 16, wherein the operation of disconnecting the first I/O card and performing switching from the first I/O card to the second I/O card is performed by an OS.

### (Supplementary Note 18)

The redundancy providing method according to any one of supplementary notes 15 to 17, wherein, when performing the detection of the correctable failure, the correctable failure detection result indicating the occurrence of the correctable failure is recorded in a memory.

### (Supplementary Note 19)

The redundancy providing method according to supplementary note 18, wherein, when performing the predictive detection, the predictive detection result indicating the existence of the sign of the occurrence of the hardware failure of the first I/O card is recorded in the memory.

### (Supplementary Note 20)

The redundancy providing method according to supplementary note 19, wherein, when disconnecting the first I/O card and performing switching from the first I/O card to the second I/O card when the result of the predictive detection indicates the existence of the sign of the occurrence of the hardware failure of the first I/O card, the result of the predictive detection is acquired from the memory.

### (Supplementary Note 21)

The redundancy providing method according to any one of supplementary notes 15 to 20, wherein, when performing the predictive detection, the predictive detection is performed on the basis of a failure occurrence history with respect to the correctable failure.

### (Supplementary Note 22)

A redundancy providing program that causes processing to be executed, the processing including:

a process of performing a detection of a correctable failure of a first I/O card;

a process of performing a predictive detection of a sign of an occurence of a hardware failure of the first I/O card when a result of the detection of the correctable failure indicates an occurrence of the correctable failure; and

a process of disconnecting the first I/O card and performing switching from the first I/O card to a second I/O card when a result of the predictive detection indicates an existence of the sign of the occurrence of the hardware failure of the first I/O card.

### (Supplementary Note 23)

The redundancy providing program according to supplementary note 23, wherein the process of performing the detection of the correctable failure of the first I/O card is executed by a BIOS.

### (Supplementary Note 24)

The redundancy providing program according to supplementary note 22 or supplementary note 23, wherein the process of disconnecting the first I/O cards and performing switching from the first I/O card to the second I/O card is executed by an OS.

### (Supplementary Note 25)

The redundancy providing program according to any one of supplementary notes 22 to 24, wherein, in the process of performing the detection of the correctable failure, the correctable failure detection result indicating the occurrence of the correctable failure is recorded in a memory.

### (Supplementary Note 26)

The redundancy providing program according to supplementary note 25, wherein, in the process of performing the predictive detection, the predictive detection result indicating the existence of the sign of the occurrence of the hardware failure of the first I/O card is recorded in the memory.

### (Supplementary Note 27)

The redundancy providing program according to supplementary note 26, wherein, in the process of disconnecting the first I/O card and performing switching from the first I/O card to the second I/O card when the result of the predictive detection indicates the existence of the sign of the occurrence of the hardware failure of the first I/O card, the result of the predictive detection is acquired from the memory.

### (Supplementary Note 28)

The redundancy providing program according to any one of supplementary notes 22 to 27, wherein, in the process of performing the predictive detection, the predictive detection is performed on the basis of a failure occurrence history with respect to the correctable failure.

### REFERENCE SIGNS LIST

1 Information processing system
2 First I/O card
3 Second I/O card
4 CPU
5 Memory
6 Bus
7 External device
10 BIOS
11 Failure processing means
20 OS
21 I/O redundancy providing means
22 I/O card disconnecting means
30 Predictive monitoring means
31 Predictive monitoring BIOS section
32 Predictive monitoring OS section
40 Common memory

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing system comprising:
a first I/O card and a second I/O card;
a BIOS that performs a detection of a correctable failure of the first I/O card;
a predictive monitoring unit that performs a predictive detection of a sign of an occurrence of a hardware failure of the first I/O when a result of the detection of the correctable failure indicates an occurrence of the correctable failure; and
an OS that disconnects the first I/O card and performs switching from the first I/O card to the second I/O card when a result of the predictive detection indicates an existence of the sign of the occurrence of the hardware failure of the first I/O card.

2. The information processing system according to claim 1, wherein the predictive monitoring unit includes a predictive monitoring BIOS section that receives a notification for notifying the occurrence of the correctable failure from the BIOS, and a predictive monitoring OS section that notifies the OS of the predictive detection result indicating the existence of the sign of the occurrence of the hardware failure of the first I/O card.

3. The information processing system according to claim 2, wherein the predictive monitoring BIOS section and the predictive monitoring OS section have a common memory in common, and the common memory records therein the correctable failure detection result indicating the occurrence of the correctable failure.

4. The information processing system according to claim 3, wherein the predictive monitoring BIOS section records the predictive detection result indicating the existence of the sign of the occurrence of the hardware failure of the first I/O card, into the common memory.

5. The information processing system according to claim 4, wherein the predictive monitoring OS section acquires the predictive detection result indicating the existence of the sign of the occurrence of the hardware failure of the first I/O card, from the common memory.

6. The information processing system according to claim 1, wherein the predictive monitoring unit performs the predictive detection on the basis of a failure occurrence history with respect to the correctable failure.

7. The information processing system according to claim 1, wherein the first I/O card is in an active mode and the second I/O card is in a standby mode.

8. An information processing apparatus comprising the information processing system according to claim 1.

9. A redundancy providing method comprising:
performing a detection of a correctable failure of a first I/O card;
performing a predictive detection of a sign of an occurrence of a hardware failure of the first I/O card when a result of the detection of the correctable failure indicates an occurrence of the correctable failure; and
disconnecting the first I/O card and performing switching from the first I/O card to a second I/O card when a result of the predictive detection indicates an existence of the sign of the occurrence of the hardware failure of the first I/O card.

10. A storage medium storing therein a redundancy providing program that causes processing to be executed, the processing comprising:
a process of performing a detection of a correctable failure of a first I/O card;
a process of performing a predictive detection of a sign of an occurrence of a hardware failure of the first I/O card when a result of the detection of the correctable failure indicates an occurrence of the correctable failure; and
a process of disconnecting the first I/O card and performing switching from the first I/O card to a second I/O card when a result of the predictive detection indicates an existence of the sign of the occurrence of the hardware failure of the first I/O card.
